(19) United States
(12) Patent Application Publication
(10) Pub. No.: US 2010/0194756 A1
(43) Pub. Date: Aug. 5, 2010

(54) METHOD FOR PRODUCING SCALEABLE IMAGE MATRICES

(75) Inventor: Maximilian Schich, Munchen (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Max-Planck-Gesellschaft zur Forderung der Wissenschaften e.V., a corporation of Germany, Munchen (DE)

(21) Appl. No.: 12/376,302

(22) PCT Filed: Aug. 3, 2007
(86) PCT No.: PCT/EP2007/006900

§ 371 Date: Feb. 4, 2009

(30) Foreign Application Priority Data
Aug. 7, 2006 (DE) 10 2006 036 826.6

(51) Int. Cl. G06T 11/20

(52) U.S. Cl. 345/440

(57) ABSTRACT

A method for producing an image matrix including providing a network with a multitude of link starting nodes and a multitude of link destination nodes with links lying between them, forming a matrix with rows and columns, wherein link starting nodes are assigned to the rows and link destination nodes are assigned to the columns or vice versa, and placing visual representations of the link starting nodes or of the link destination nodes in place of the links in the matrix, resulting in the image matrix.

### RELATED APPLICATIONS

This is a §371 of International Application No. PCT/EP2007/006900, with an international filing date of Aug. 3, 2007 (WO 2008/017430 A1, published Feb. 14, 2008), which is based on German Patent Application No. 102006036826.6, filed Aug. 7, 2006.

### TECHNICAL FIELD

This disclosure relates to a method for producing image matrices. The method covers the technical fields of image science, data processing and the science of complex networks.

### BACKGROUND

An image matrix is, in general, a two-dimensional arrangement of images in rows and columns. The position of an image (row, column) in the image matrix represents information about the relationship of the image to the contents (significance) of the associated row and column positions and a relationship between the row and column positions. An image matrix is a visualization (display) of the images, which conventionally enables the observer to recognize relationships between images and/or between row and column positions.

Image matrices have existed at least since the Klosterneuburg Altar, created in 1181 by Nicolaus of Verdun, which visualizes a network of typological references in the Bible. A modern example is the architecture project ‘Schedule of Las Vegas Strip hotels’ (see http://www.library.univ.edu/arch/lasvegas/map/index2.html or in the book ‘Learning from Las Vegas’ by Venturi, Scott-Brown and Izenour (London/Cambridge 1977)), wherein each row of the image matrix is assigned to one hotel in Las Vegas, for example, the “Paris” hotel, and each column of the image matrix is assigned to one feature of the hotel, for example, the appearance of the facade. Observing the image matrix enables, for example, a comparison of the features of the hotels.

Common to all the known examples, however, is the fact that the image matrix is created in that the depictions (images) contained therein are especially created during the creation of the image matrices. An initially empty table is filled with new images. A conventional image matrix only represents a systematic presentation of previously available information, but without allowing further evaluation of the information. Conventional image matrices generally present exclusively positive correlations, that is, the presence of a relationship between features, but not negative correlations, that is, the absence of such a relationship between features.

It is known from the prior art that the investigation of relatively large quantities of classified objects is usually connected with individual representations (such as data sheets of a single object) or with one-dimensional list representations (for example, results lists or one-dimensional overview tables).

Phenomena, in which a connection exists between the classification and the visual properties of the objects or of the classification criteria can therefore only be investigated with difficulty using conventional image matrices.

It could therefore be helpful to provide an improved method which overcomes the aforementioned disadvantages. It could also be helpful to provide a storage medium or an electronic data-processing system, which comprises a processor and a storage medium to carry out the method.

### SUMMARY

We provide methods including the provision of a network comprising a multitude of link starting nodes and a multitude of link destination nodes with links lying between them is followed by the formation of a matrix with rows and columns, wherein link starting nodes are assigned to the rows and link destination nodes are assigned to the columns or vice versa. Finally, the sought-for image matrix is created in that visual representations of the link starting nodes or the link destination nodes are placed in the matrix instead of the links.

In contrast to existing image matrices which are created by filling an empty table with specially created images, in the method described, existing image information from the nodes of a (classification) network is placed instead of the links in the cells of the matrix. An image matrix is provided which encompasses visualization (display) of images and advantageously enables the observer to recognize or establish relationships between images, and/or to subject the images to data-processing and/or data maintenance. The advantage lies particularly therein that, when dealing with relatively large quantities of classified objects, our method facilitates the investigation of phenomena in which a relationship exists between the classification and the visual properties of the objects and/or the classification criteria.

The method also facilitates, inter alia, the explication of direct dependencies and the extraction of diachronic phenomena from a given quantity of classified (image) data. Contrary to conventional list representations and overview tables, the method also allows the simultaneous investigation of data in the context of two data dimensions. Compared with the prior art, this means a significant acceleration of the work, since complex navigation within the body of data is no longer necessary.

The method advantageously represents a fully or partially automated tool for processing large bodies of data. The image matrix can be constructed from the body of data without prior knowledge, in particular without the user knowing about existing correlations between data.

According to an advantageous example of the method, link starting nodes of the aforementioned network are classifiable objects and link destination nodes are classification criteria, or vice versa.

According to another advantageous example, objects and/or classification criteria are taken from a number of persons, locations, time periods, physical items, conceptual items, events and periods. An event is the coincidence of a plurality of the aforementioned objects in a node, for example, the coincidence of a physical item, a locality and a time period in a stopover event. Periods are, inter alia, continuous, non-discrete extensions in one or more of the stated object dimensions, for example, a style period which has a spatial and a temporal extension over a plurality of locations and time periods.

An advantageous example of the above features is created when objects and/or classification criteria are represented by individual nodes or as a group of nodes. Objects and classification criteria which are represented by a group of nodes have multiple parts. Between multi-part objects and classification criteria, there may possibly be ‘multi-valent links,’ since more than one node of the respective multi-part object or classification criterion can be linked. Herein, multi-part objects may possibly only be linked to a classification criterion indirectly, for example, via lower-level partial nodes. Since the relationship between the starting node and the destination node expressed in the value of the matrix cell thereby gains significantly in complexity, it is herein designated an ‘edge’ for better differentiation. The edge between a (multi-part) object and a (multi-part) classification criterion can contain one or more links or can be empty.

It is provided in a further advantageous example of the method that, in the case of a multi-valent link from and/or to a multi-part object or a multi-part classification criterion, either a detail image matrix, a one-dimensional overview table or an image montage is placed.

In another advantageous example, it is provided that, on provision of an input signal, multi-part, in particular hierarchically sub-divided, objects or classification criteria in the matrix are unfolded into a plurality of matrix rows or matrix columns or are grouped together into one matrix row or matrix column.

In a further advantageous example, it is provided that individual objects and/or classification criteria in the image matrix can be bound based on precisely specifiable relationships.

Advantageously, the image matrix can be output in the course of the method to an output device, in particular, onto a screen or a printer, or in a file.

According to a further advantageous example, it can be provided that further information which is called up from a database can additionally be placed at the matrix elements of the image matrix and may belong to the respective link starting nodes or link destination nodes. Additional information of this type may include, for example, further data concerning a visualized image.

According to a further advantageous example, a data processing system can be provided wherein the data of the image matrix (images, text and/or further information concerning the matrix elements) are subjected to further processing, preferably data input, image recognition, correlation and/or reordering of the data. The processed data are then stored and/or output as a processed (modified) image matrix.

According to a further advantageous example, the storage of the processed data can take place in a body of data from which the network is prepared. Advantageously, the information in the body of data can thus be automatically enriched and completed for further use.

Advantageously, the aforementioned developments enable:
a) simplified handling of the ambivalence of the higher unit of objects and classification criteria (advantage 1),
b) a simpler approach to the substantiation of the correlation of objects (advantage 2),
c) extraction of time-bound phenomena with regard to the objects as well as the classification criteria (advantage 3),
d) easier answering of implicit visual detail questions (advantage 4), and
e) facilitation of analysis and revision of the starting body of data (advantage 5).

A detailed explanation of advantages 1 to 5 above will be given following the explanation at the end of the description.

The method can be used, for example, in the fields of bibliometry (explication of implied image quotations), art history (adoption, tradition-formation, Mnemosyne), complex networks science, and for questions regarding copyright.

Other aspects of this disclosure include a storage medium and/or an electronic data processing system, which comprise a processor and a storage medium, wherein the storage medium contains software which enables the processor to carry out the method.

### BRIEF DESCRIPTION OF THE DRAWINGS

Further advantages and details are illustrated in the drawings and will now be described in greater detail, making reference to preferred examples. In the drawings:

FIG. 1 shows a flow diagram illustrating the method;

FIGS. 2a-c show matrices with increasing information content;

FIG. 3 shows the formation of the image matrix, wherein visual representations of the nodes take the place of the links;

FIGS. 4a-c show image matrices with increasing information density;

FIG. 5 shows how the assembly of relevant partial nodes within an image matrix leads to better comparability of the representations;

FIG. 6 shows three simple steps from the matrix to the image matrix;

FIG. 7 shows a block diagram of the general procedure for producing an image matrix;

FIG. 8 shows the raw form of the base list (adjacency list);

FIG. 9 shows the extraction of different record numbers (node IDs) in the base list, allowing the external answering of simultaneous local, global and metalocal queries or the reconstruction of a tree structure;

FIG. 10 shows the general procedure for producing a matrix (detail from FIG. 7);

FIG. 11 shows a section of a matrix;

FIG. 12 shows a section of an image matrix;

FIG. 13 shows an illustration of an edge which can contain, in matrix rows or matrix columns of different grouping, a different number of links;

FIG. 14 shows a detail image matrix which offers a better assignment of information, whereas a detail overview offers larger depictions on a comparable area;

FIG. 15 shows the scaling or zooming of a matrix: local>metalocal>global; and

FIG. 16 shows rigid node trees, which enable zooming similarly to the scrolling in or out of the index tree in a conventional operating system (icons as per Windows Explorer™).

### DETAILED DESCRIPTION

The disclosure will now be described in terms of its structure and operating method, making reference to the drawings. Various aspects will be described, using examples relating to the fields of image. science and art. However, the carrying out of the method is not limited to these applications, but rather is possible over a wider range, as set out, by way of example, below. Some of the figures illustrate individual text features in particular for the construction of a matrix or image matrix, for example, table values which for printing reasons are only reproduced in small size and can partially be interpreted as illustrating images.

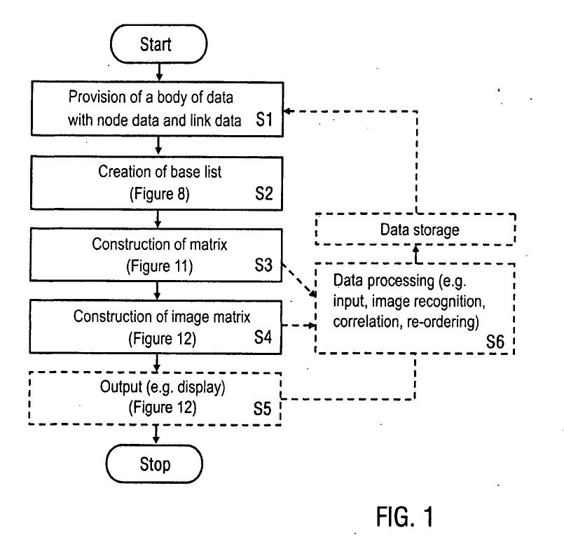

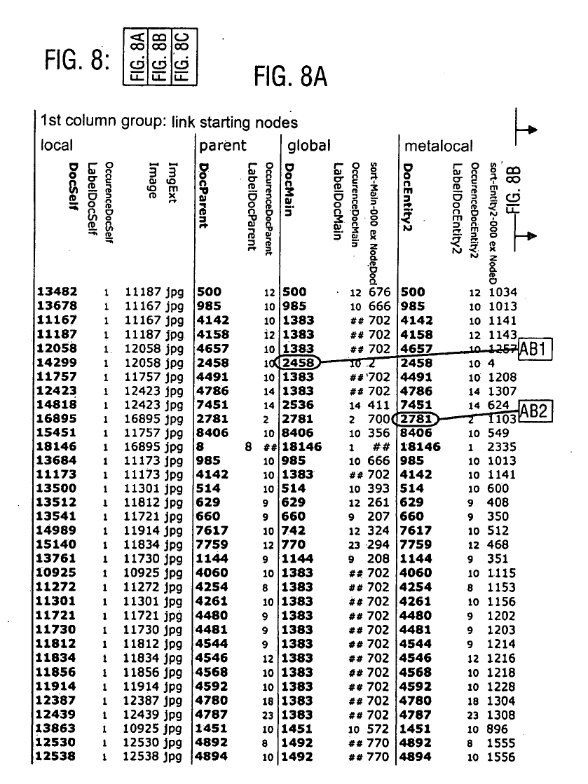

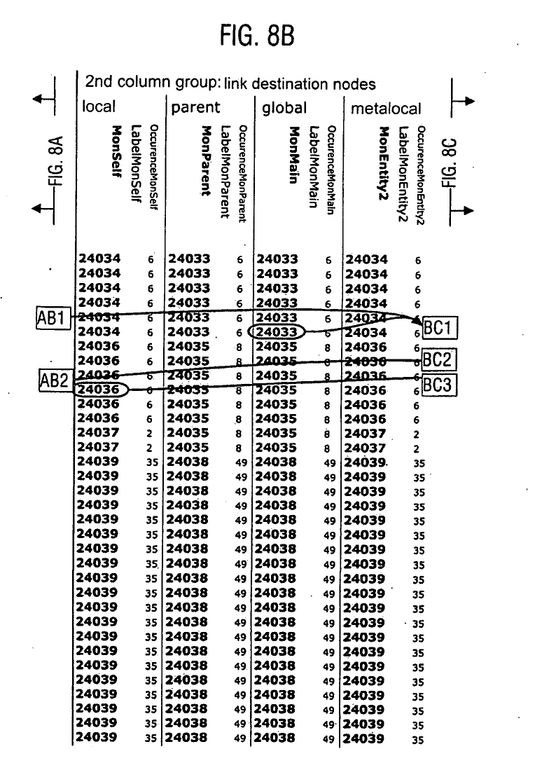

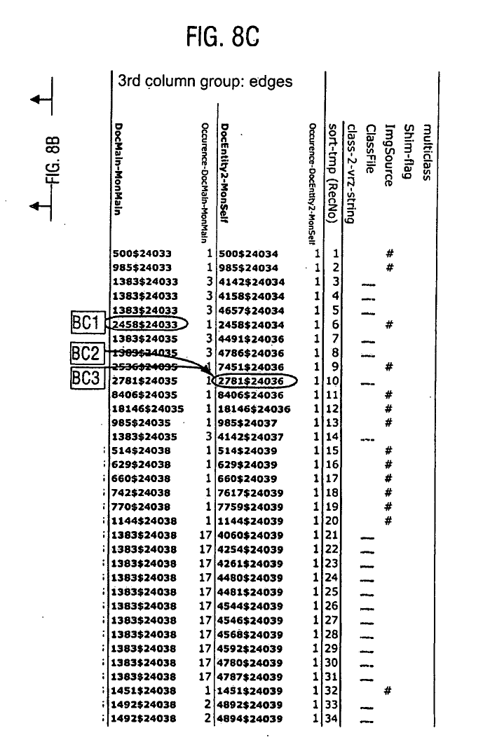

The main steps of a preferred example of the method are shown in FIG. 1 and in the block diagram of FIG. 7. Initially, in step S1, the provision of data in at least one database (‘body of data’ in FIG. 7) takes place. The data include data from link starting nodes, data from link destination nodes and data which characterize the links between the link starting nodes and the link destination nodes. The data can generally be present as image and/or text data, wherein the data from at least one of the link starting nodes and the link destination nodes can be visualized (for example, including the set text of a scanned book page). In step S2, the data are prepared in the form of a base list (‘BASE’ in FIG. 7, with the content shown, for example, in FIG. 8), which contains all the information required for the construction of the matrix and the image matrix. The base list is a data list with the structure as described below and is stored in a data store which can be linked to the database or is extracted therefrom.

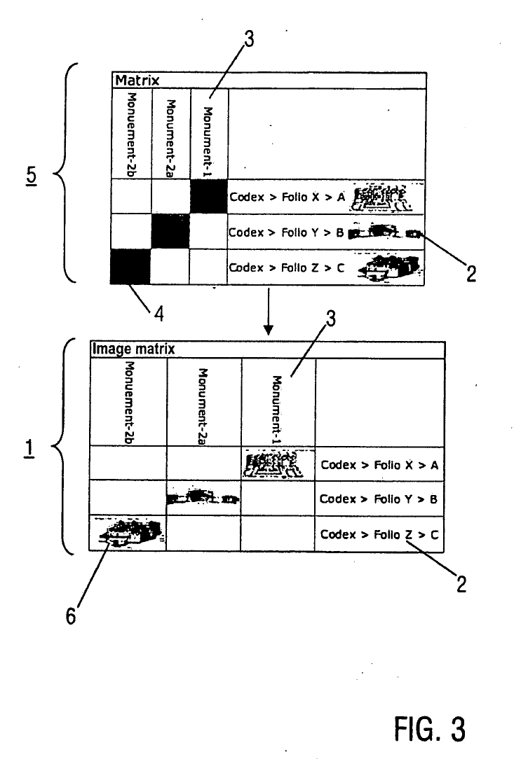

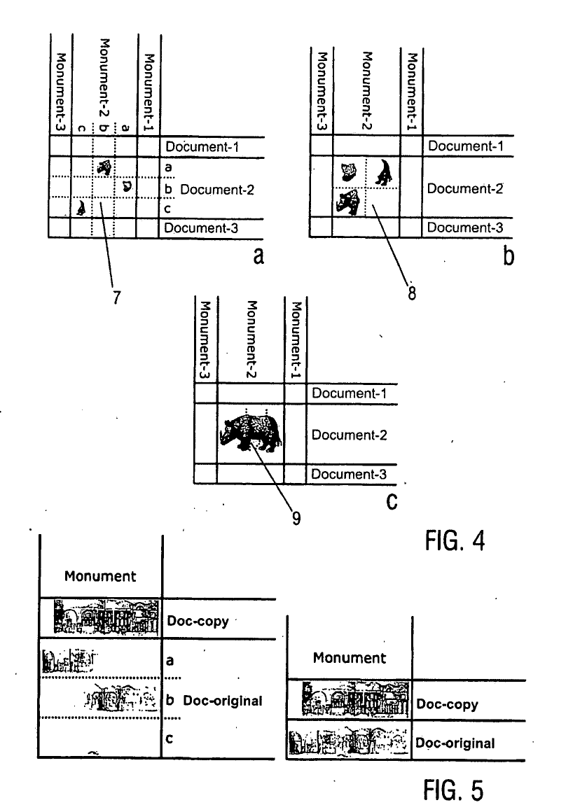

On the basis of the information contained in the base list, a matrix is constructed in step S3, of which the row and column positions are formed by the listing of the link starting nodes and the link destination nodes (or vice versa). The matrix elements (i.e., the cells of the matrix) comprise a zero (no information) if, between the link starting nodes and the link destination nodes of the associated rows and columns there is no link, or a matrix element which comprises information about a mono-valent or multi-valent link, between the associated link starting nodes and link destination nodes. This information is obtained from the ‘edge set’ information of the base list. A function (subprogram) with which enquiries are made as to whether the relevant combination of row and column occurs in the ‘edge set’ is placed at the relevant matrix elements. If this is the case, the valency of the relationship (valency of the link) is queried. In the case of a mono-valent link, the image of the associated link starting node is placed at the site of the matrix element (FIG. 3). In the case of multi-valent links, a detail matrix (FIG. 4a), an overview table (FIG. 4b) or an image montage (FIG. 4c) is placed at the site of the matrix element.

Finally, in step S4, the desired image matrix is constructed from the matrix in that the matrix elements are replaced by visual representations of the associated link starting nodes or link destination nodes. Herein, a selection of the visual representation can be made depending on the valency of the link (edge value).

In general, with the provision of the image matrix, a finished result of the method has been achieved. The image matrix comprises the data of images, which are allocated to the rows and columns of the image matrix and, possibly, additional information. The data are available to a user who wishes, for example, to investigate the relationships between images and/or between the row and column positions.

The further use of the image matrix is simplified if at least part (a section) of the image matrix is output. Output of the image matrix can be made to a display device (e.g., a display or a print-out) or to a data store (step S5). For the output of the image matrix, decryption of the image matrix takes place.

Optionally, following step S3, S4 and/or S5, further data-processing can be provided wherein the images, texts and/or further information of the image matrix are subjected to further processing (step S6). Further information can be input, for example, from other data resources, to enrich further the information represented by the image matrix. Image recognition can be provided to record and evaluate particular images (patterns) in the cells of the matrix. A correlation can be made between the particular partial images, possibly after image recognition, to generate relationships. In addition, reordering of the data can be provided. The data processing in step S6 can be carried out by a user or automatically with readily available data processing programs set up for the relevant functions, for example, image recognition or correlation. In the event of a jump from step S3 directly to the data processing (step S6), the image matrix is created (step S4) after repeated execution of S1 to S3, following S6.

The processed data are then stored. Storage can take place in the original body of data or in a separate store. Alternatively or in addition, a modified image matrix can be constructed with the processed data.

The details, in particular, of steps S1 to S4 will now be described. The practical implementation is carried out with methods and software tools that are per se known, for example, a table calculation or HTML, the details of which are not described here. Alternatively, the method can be implemented, for example, in the context of an application within the ‘Semantic Web’ with the aid of JAVA and AJAX or the like.

### 1. Introduction

A body of classified objects can be understood, for example, as a network of nodes and links. Herein, objects and classification criteria each comprise a type of node; the allocation of an object to a classification criterion is carried out by means of a classification link. The classification network thus defined can be constructed as a matrix like any other network.

If the classified objects are visually depictable items, then it is possible to enrich the conventional matrix accordingly and convert it into an image matrix. For this purpose, the simple links are replaced by depictions of the network nodes, that is, depictions of the objects and/or classification criteria. In many cases, it is useful to pick out part of the object which corresponds to the linked classification criterion or vice versa. The method therefore appears to be particularly useful if the objects and/or classification criteria in question are present in a sub-divided, possibly hierarchical, form or in a form which allows grouping together into higher-level units.

The visually displayable objects can assume the role in the method both of the object and—in special cases—that of the classification criterion. Suitable items in the role of the object will also be referred to below as image documents. An image document is defined as any object that is or can be visually represented and/or as a collection of a plurality thereof. Typical examples of image documents are a book with illustrations, a book with scanned text pages, a hand drawing, a sketch book, a photograph, a photograph collection, the photographs of an interne user or a home page.

Typical examples of classification criteria that can be grouped together are bodies of key words or ‘tags,’ which can be grouped into meaningful groups such as ‘tag clusters.’ Typical examples of sub-divided classification criteria are hierarchical systematics, thesauri and ontologies. Classification criteria which can be sub-divided in a more or less complex manner and simultaneously grouped together into higher units are bodies of discrete objects such as web sites, places or physical and conceptual items. In particular, objects created by humans, such as ancient monuments, historic buildings or paintings occur frequently both in the role of the classification criterion as well as that of the object, for example, if the classification link describes the indeterminate or directly demonstrable dependency of an object on other objects (by adoption or tradition-formation).

In the present context, the image matrix is understood to be a special form of the conventional matrix. The matrix therefore constitutes the starting point in its production. It is initially enriched with the necessary information for nodes and links and then converted in a simple step to an image matrix. The enrichment material can come either directly from the original body of data or be placed and stored in a new adjacency list. This new adjacency list serves during the processing and analysis of the image matrix as a temporary database. It is referred to below as the ‘base list.’ The base list can contain either the entire network of original data or just part of it and must be created anew or updated after every relatively large change.

Some fundamental principles of matrices and image matrices will now be described. Thereafter, a possible base list will be described, by way of example, and its production described in greater detail. Starting from this point, the creation of a matrix and the associated image matrix will be explained. Then, scaling or zooming of the (image) matrix, that is, the handling of the possible groupings and sub-divisions of the network nodes, will be considered. Finally, various advantages of the method and of the image matrices thereby created will be set. out.

An example of a network for visualization is adoption. It contains as sub-divisions ancient monuments, that is, works of art or building complexes. The role of the objects is taken by (image) documents, that is, visual sources in which the antique monuments are represented.

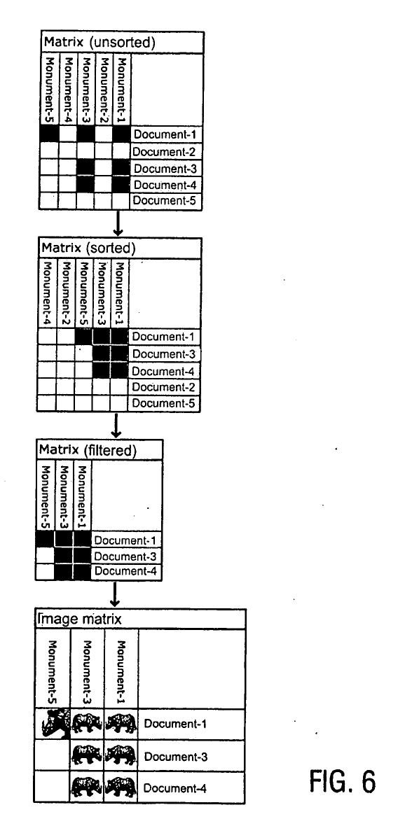

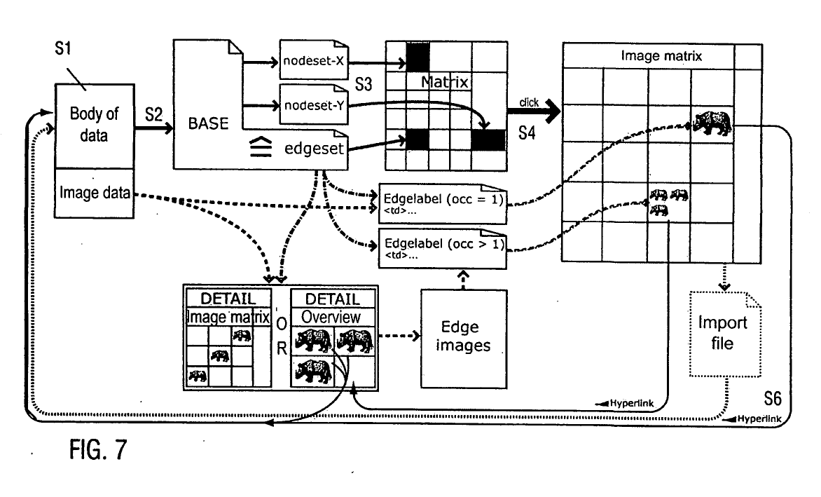

For the user of a completed implementation of the method described, the general work sequence is completed with the creation of an image matrix involving, in general, a few simple steps (FIG. 6). Firstly, after possible sorting of the matrix (permutation), as many correlating rows and columns of the matrix as possible are brought together so that a region with a particular density of filled cells is produced (edge value greater than or equal to 1). In a further step, the rows and columns that are not needed are filtered out so that only the relevant region remains visible. Finally, the filtered region is converted, with a click, into an image matrix.

In the background, the technical process includes a number of processes which can be automated and with which the final user does not need to come into direct contact (see FIG. 7). They will now be explained in detail.

### 2. Matrix and Image Matrix

In a matrix, the nodes of a network are represented as rows and columns and the edges (monovalent or multi-valent links) as points or cells. An important difference from classical network visualization, wherein the nodes are represented as points and the links as lines, consists in the radically different possibilities for enrichment with additional information. Whereas a network representation is primarily suited to identifying the location of the nodes, whatever its type, the matrix suggests itself primarily for making visible sequential structures such as the dating of items. Permutation, that is, the sorting and grouping of rows and columns assumes an important role therein.

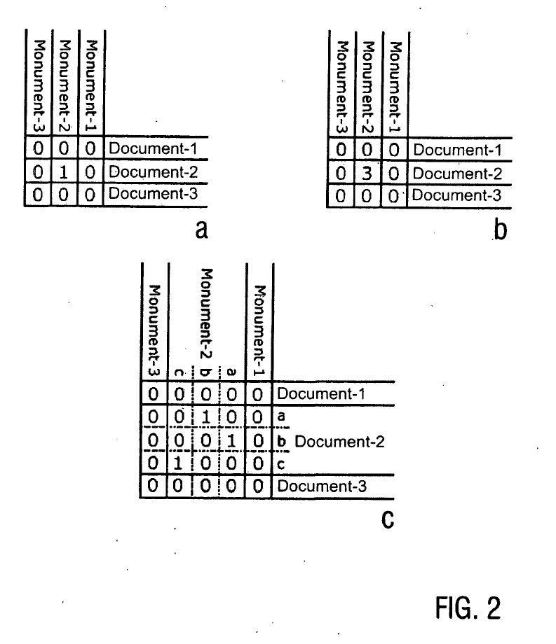

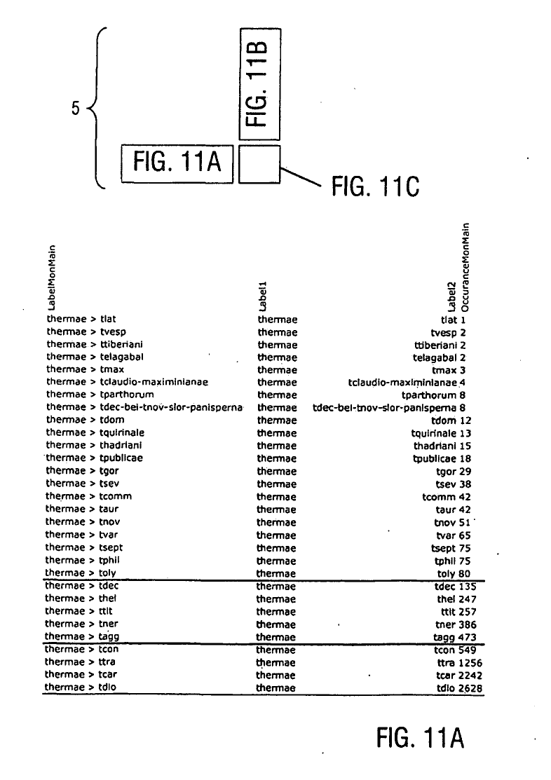

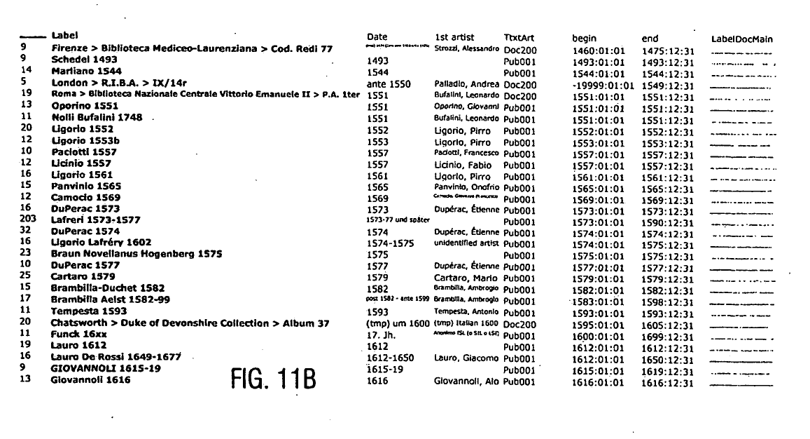

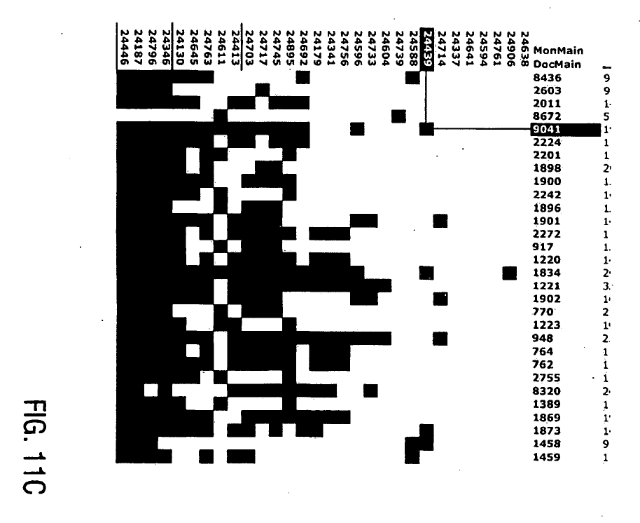

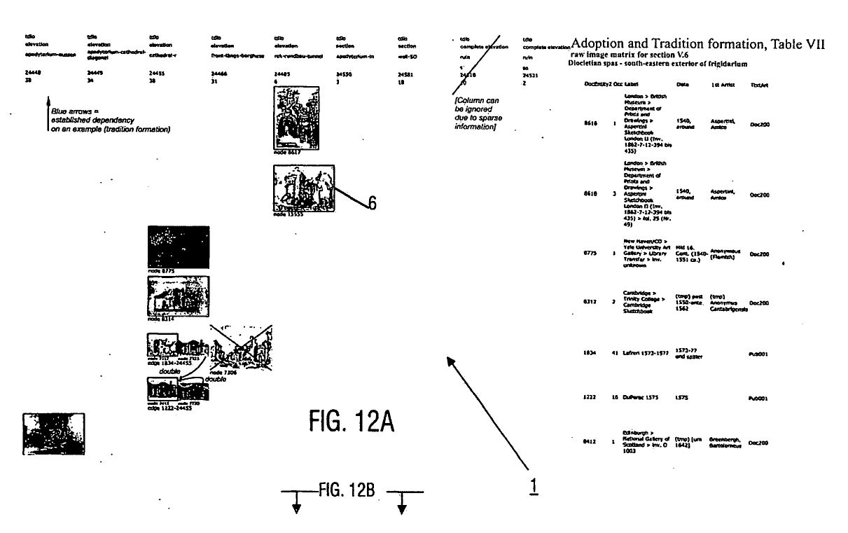

If a network is formed as a matrix from links and nodes, then at the corresponding intersection point of two linked nodes, either a ‘0’ or a ‘1’ is placed, depending on whether a link is present or not (FIG. 2a, FIG. 11).

Even this simple form of matrix is highly useful, since it can lead to calculation operations and analyses being performed in the respective network. The known bandwidth extends from the extraction of possible navigation paths to the establishment of useful groups by permutation, that is, swapping rows and columns (as in the prior art).

Extending the simple matrix involves weighting the links with a particular value. This is useful, for example, in a network in which origin and destination nodes of the links are brought together into groups or hierarchical structures. The value of the matrix cell designated ‘edge’ in the following corresponds here to the number of actually assigned links between the respective groupings. The grouping and weighting of the matrix rows and columns can be realized, as provided in the prior art, with ‘block modelling’ in a ‘Social Network Analysis.’

If, between the higher-level object (e.g., a document complex) and a the higher-level classification (e.g., a monument complex), there are three links (that is, for example, three drawings in a sketch book of different parts of the Pantheon in Rome), then the associated value is ‘3’ (FIG. 2b). The weighted value of an edge of this type represents, strictly speaking, a detail matrix of the individual partial nodes of the respective complexes (FIG. 2c).

From the cases cited, there are three possibilities for the matrix: at the location of the respective edge, either a ‘0’ or a ‘1’ (corresponding to link present or not), a value greater than ‘1’ (if the link is a grouping together of a plurality of links) or a detail matrix (if the partial links are to be explicitly shown).

To complete the step from the matrix to the image matrix, the content of the edges is replaced by the depiction of the linked (partial) document. Formulated more generally, the depiction of suitably classified (detail) nodes takes the place of the links between the nodes of document and classification (FIG. 3).

In place of a 1, therefore, an image or the text of the linked (partial) document appears in the matrix. It is advantageous if the corresponding quadrants are referenced in an existing depiction or cut out therefrom.

The individual (partial) documents and (sub-) classifications can also be grouped together in the (image) matrix into higher-level (global) or intermediate (metalocal) units. Weighted edges with a value of greater than 1 do not represent a single link in the matrix, but a plurality of links between the linked nodes, which may possibly consist of .a plurality of parts grouped together. Herein, there are three fundamental possibilities:
The simplest method is the use of the detail matrices (FIG. 2c) and their filling with the individual quadrants they contain (FIG. 4a).
The second method is the filling of the cell with the depictions of the relevant individual quadrants, but without maintaining the order of the detail matrix—a procedure which is useful particularly in the case of extensive detail matrices, since otherwise the depictions often become too small (FIG. 4b).
The third method involves the assembly of the detail representations (FIG. 4c) included—an often useful application which markedly improves comparability, particularly in the case of moderately higher-level units: in the left-hand part of FIG. 5, three details are shown from a manuscript codex from the 16th century (‘doc original’), each of which is linked to a particular section through an ancient building (‘monument’). Mounted in the right-hand part of FIG. 5 are three parts, as intended by the authors of the codex. A comparison with the clearly independent section of a further drawing collection (‘doc copy’) which is also visible in the matrix is much easier thanks to the montage in the second depiction.

The great problem in the use of montages of this type is the nature of the higher-level query: strictly speaking, the montage possibly represents the link between an ideal higher-level document unit and the corresponding higher-level classification criterion—a relationship which possibly does not exist at all in this form in the original body of data, since there, as a rule, only the links between actually existing (partial) documents and possibly lower-level classification criteria are recorded. The image matrix therefore proves to be an independent product by means of the use of the montages. It is not a pure depiction of the existing data, but, in its expressiveness, reaches beyond that which merely exists.

Despite the problems associated therewith, the enrichment of the image matrix with montages is useful in many cases, since a plurality of (partial) documents can also be regarded as part of higher-level or entirely independent, ideal (document) concepts. By this means, for example, individual sketches from different historical sketch books can be brought together in a reconstruction project that is to be undertaken. Fragments of a single representation can possibly be combined, for better comparability, into an incomplete overall representation. As a result of the increased comparability produced, possibly unknown dependencies could possibly be discovered (see Advantage 2).

### 3. Description of the Base List

The aforementioned ‘base list’ (FIG. 8), or a dynamic equivalent, can either exist implicitly in the original body of data or can be created externally. For printing reasons, the base list in FIG. 8 is shown in three partial images (FIGS. 8a, 8b and 8c). The base list contains information concerning nodes and links in the original body of data. A variety of connections can occur between nodes, as shown schematically in FIG. 8. FIG. 8 shows that the extraction of various record numbers (node IDs) in the base list enables an external response to simultaneous local, global and metalocal queries and/or the reconstruction of a tree structure.

In principle, the base list is an adjacency list enriched with metainformation concerning nodes and edges of a network, the list being able to serve either for the production of scaleable (image) matrices or the production of classical network visualizations. (Image) matrix and network visualization require a ‘Nodeset’ (set of nodes, group of information items concerning the nodes of the network) and an ‘edgeset’ (set of edges, group of information items concerning the edges of the network). Both are contained in the base list or can be created dynamically therefrom. Enrichments which are also present can serve to improve sorting and a clear representation of the respective end product. By combining different base lists, it is also possible to link the different types of network (for example, adoption, tradition-formation or a tree structure) in a single visualization.

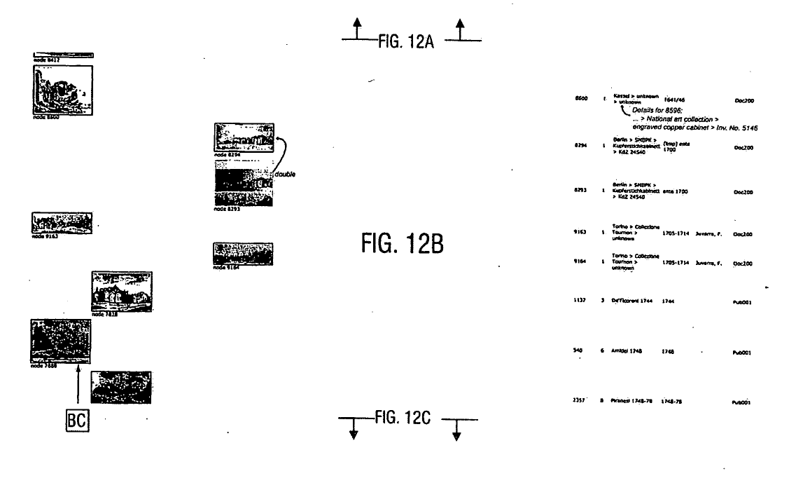

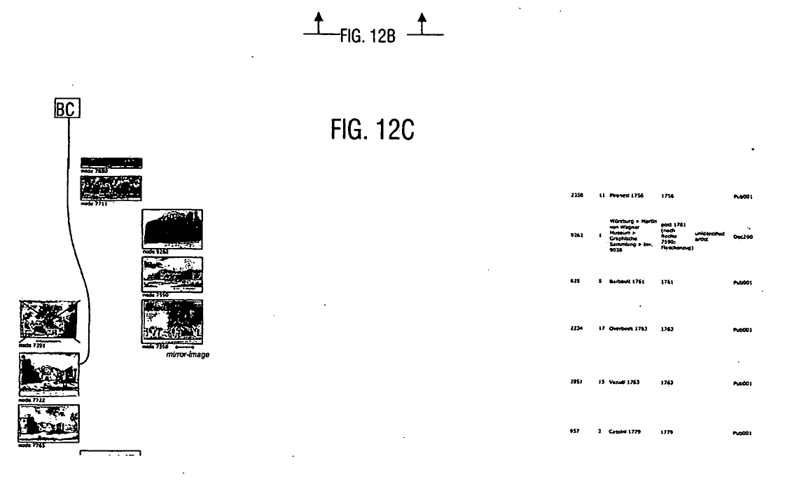

In this context, the image matrix of an adoption network in FIGS. 12a-12c shows, in superposition with a second network in a classical network visualization: the network for tradition-formation.

By way of example, an external base list separated from the original body of data, and its production will now be described. The starting point is database output (step S1 in FIG. 1) which contains all the relevant link relationships of an adoption network. In a second step, the simple adjacency list of the links produced therefrom is enriched with node information from a further read-out from the database. The procedure is similar with regard to every selected partial network. For each link type in the original body of data, a separate base list can (and as a rule, should) be drawn up.

If the base list is represented as a flat table (spreadsheet), it suitably includes three groups of columns (FIGS. 8a, 8b and 8c)—one for link starting nodes, one for link destination nodes and a further one for the edges resulting therefrom. Each line in the list represents a real existing link in the original body of data (the ‘self-self-edge’).

The Nodeset, that is the information concerning the nodes of the network can be extracted from the first two groups of columns of the base list. The edgeset corresponds to or results from the third column group.

The first two groups of columns of the base list (FIGS. 8a, 8b) of nodes are each sub-divided into four sub-groups corresponding to the grouping, which will be explained in greater detail below, of ‘self,’ parent, ‘main’ and ‘entity2’ of the respective link starting node or link destination node. Each of the sub-groups contains, in the first position, the ‘record number’ (or possibly an arbitrary other node ID), in the second position, the ‘label string’ and, in the third position, the ‘occurrence.’

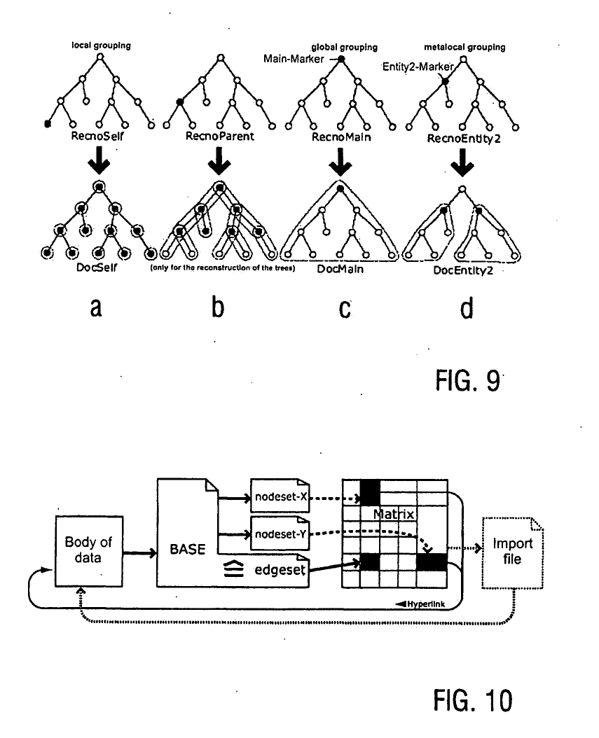

The first column of the four sub-groups of nodes in the base list contains the ‘record number’ of the starting node or the destination node or of the corresponding node of the relevant grouping (see FIG. 9, ‘RecNo . . . ,’ corresponds in FIG. 8 to ‘Doc . . . ,’ for example, ‘DocSelf’ or ‘Mon . . . ,’ for example, ‘MonSelf’):

‘RecNoSelf’ is the record number of the node read out itself.

‘RecNoParent’ is the record number of the first higher-level node in any existing node hierarchy (part-of-link). It serves, for example, in a network visualization, to display the tree structure of a document in addition to adoption and tradition-formation. It plays only an indirect role in the grouping of higher-level units.

‘RecNoMain’ is the record number of the node at the peak of the respective node hierarchy which coincides with the ‘global’ document unit. For this purpose, on a read-out, the node hierarchy is followed upward as far as a marking stipulation. For this purpose, each node at the peak of a document tree is marked accordingly as ‘Main’ before the read-out.

‘RecNoEntity2’ is the record number of possibly existing, idiosyncratic useful ‘metalocal’ unit of the document which is identified with the aid of the marker ‘Entity2.’ As with ‘RecNoMain,’ the node hierarchy is followed upward on a read-out until the marking stipulation.

The given node identifications in FIG. 9 can, for example, point with ‘RecNoSelf’ to a particular image in the book, ‘RecNoParent’ can point to the immediately higher-order page in the book, ‘RecNoMain’ to the book itself, and ‘RecNoEntity2’ can point to a catalogue entry covering several pages in the book.

The second column of the four sub-groups of nodes in the base list (FIG. 8) contains the ‘Labelstring,’ which serves to enrich the respective nodes in the matrix with useful information.

As a rule, this means that if origin and destination nodes are of different types, it is suitable to define two different formats for the ‘Labelstring’ A useful label string will now be explained, by way of example, for (image) documents and then another for the classification (ancient monuments in this case).

### Labelstring Document:

RecnoSelf|RecnoParent|RecnoMain|RecnoEntity2|Type|LabelSelf|
Label|DateName|begin|end|1stArtist|ImgFile

At the start of the label string of the (image) documents are the record numbers which have already been described and which serve for grouping according to higher-level units (see FIG. 9).

‘Type’ suitably specifies the node type of the entry that is read out, that is, in the case of documents, for example, whether it is an individual item, a publication or a photograph that is concerned.

‘LabelSelf’ contains exclusively the designation of the node itself. It is necessary if, for example, the tree structure of a document is to be visualized as a network without showing redundant information on the nodes of the tree.

‘Label’ contains the complete designation of the node and it can also contain information relating to higher-level nodes or, in the case of the document location, suitably, hypotactically linked nodes can be included. The label corresponds in the case, for example, of individual objects more or less to the sequence ‘Place/institution/department: codex/folio/quadrant’ and for publications, the sequence ‘Abbreviated name/location.’

‘DateName’ contains, for example, the designation of the (first) time range called upon for dating. (Documents can naturally also be dated concurrently, that is multiple times, with inclusion of the dating origin, for example in the case of a divergent research opinion.)

‘begin’ and ‘end’ contain the numerical start and end time-points belonging to ‘DateName’ that are necessary for sorting, in the form +/−YYYY:MM:DD (=year:month:day).

‘1stArtist’ contains the first person linked to the document under the condition ‘artist.’ (Naturally, all the associated artists or other persons can also be placed at this point.)

‘ImgFile’ contains the reference to the relevant image file corresponding to the database entry, or in the case of only secondary reprographically reproduced documents, a reference to the image file of the first dependent document, if it is a photographic copy.

In addition to the components cited, the label string of the documents can also be enriched with other additional information—such as GIS information concerning the locality. Labelstring classification:

RecnoSelf|RecnoParent|RecnoMain|RecnoEntity2|LabelSelf|Label

The Labelstring of the classification criteria corresponds, with regard to the basic data, to that of the (image) documents. If the classifications are relatively complex creations, for example, ancient monuments or documents, the corresponding Labelstring can be similarly rich in information as the Labelstring for the document. In the present case, no additional enrichments regarding sorting are included. The function of the fields included corresponds to the explanations concerning the Labelstring of the documents.

The third column of the four sub-groups of nodes in the base list (FIG. 8) contains the ‘Occurrence’ of the nodes. It gives the relative frequency of the respective entry in the sub-group. It is obtained simply by counting the similar ‘record numbers’ in the first column of the sub-group. It corresponds to the starting node-OUT-level or the destination node-IN-level.

It should be noted that the ‘Occurrence’ must be recalculated in the case where the ‘base list’ is limited to a partial quantity of the original body of data. Simple reading out of the total number of links to the entry from the original body of data may not be useful under certain circumstances, since the limitation does not have to correspond to the available data in the original body of data.

In addition to the ‘Recordnumber’, ‘Labelstring’ and ‘Occurrence,’ the sub-groups of both groups of columns of nodes in the base list can also contain information concerning depictions and sorting.

The fields ‘Image’ (and ‘Imgext’) in the column group ‘DocSelf’ (FIG. 8) contain the reference to the relevant image file or to the relevant section from an image file which is of importance to the image matrix. The record number given therein may differ from that of the node itself, for example when the image file comes from a reprographically produced copy—a peculiarity which can be identified by a marking in the image matrix.

The ‘Sort’ columns in the column groups ‘DocMain’ and ‘DocEntity2’ (FIG. 8) originate from the sorting of matrices created from the base list. For this purpose, the information is possibly imported back, by means of a macro, into the base list. This is useful since the effort of partially manual sorting of the matrices, for example, simply downwardly, that is from the ‘global’ grouping ‘Main’ to the ‘metalocal’ or ‘local’ grouping ‘Entity2’ or ‘Self’ can be inherited.

The third column group of the base list (FIG. 8c) of the edges contains, starting from the three grouping levels ‘Self’, ‘Main’ and ‘Entity2,’ up to nine sub-groups (3 link origin points and 2 link targets). Of these, only the two relationships ‘DocMain-MonMain’ and ‘DocEntity2-MonSelf’ are shown.

Each sub-group contains, in the first column, the relevant edge which arises as a consequence of simple linking together of the corresponding record numbers. The second column of each subgroup contains the ‘edge occurrence’ which is calculated in exactly the same way as that of the individual nodes. The ‘edge occurrence’ can serve, for example, as an indicator for the documentation density of various classification complexes in an extensive document. The quality of information is naturally variable, since, for example, a single good drawing can have far greater significance than numerous poor sketches.

4. Creation of the Base List (step S2)
4.1. Reading out from the Raw Adjacency List

The raw form of the database output corresponds, in the case of the simplest link between the starting nodes and the destination nodes, to the following form:

Database read-out “Edges”:

| Linkroots | Linktargets. . . |
|---|---|
| RecnoDoc1 RecnoMon1 RecnoMon2 RecnoMon3 | |
| RecnoDoc2 RecnoMon4 | |
| RecnoDoc3 RecnoMon2 RecnoMon5 | |
| ... | ... |

For this purpose, the required result in the database must only contain the starting nodes of the links. They appear in the output in the first column. The targets of the links appear in the subsequent columns. Both the link starting nodes and the link destination nodes are represented exclusively by their ID (record number, primary key or URI . . . ).

In the next step, the raw database output of the link relationships is converted into a two-column form:

Raw-Edgelist (adjacency list):

| Linkroots | Linktargets |
|---|---|
| RecnoDoc1 RecnoMon1 | |
| RecnoDoc1 RecnoMon2 | |
| RecnoDoc1 RecnoMon3 | |
| RecnoDoc2 RecnoMon4 | |
| RecnoDoc3 RecnoMon2 | |
| RecnoDoc3 RecnoMon5 | |
| ... | ... |

Each link starting node therefore has one single link destination node as a counterpart. Every line therefore contains a single link relationship which also exists explicitly in this form in the database. If the links are represented in the original body of data, for example, as an independent event node (or as a contingency table in the case of a relational database), then the result of these events can also be read out directly. The output then immediately corresponds to the two-column form.

### 4.2. Enrichment of the Raw Adjacency List

In the further course of the procedure, the two-column adjacency list is enriched with additional node information. This allows the grouping of the nodes and link relationships to global and metalocal units in the matrix and, simultaneously, the sorting of the (image) matrix according to criteria of the respective nodes such as designation, locality, dating or artist.

The enrichment of the raw adjacency list is carried out on the basis of simple database read-outs of all the relevant nodes (e.g., documents and monuments) in the form of the above described ‘Labelstring.’ For this purpose, it is not usually necessary to create a specially adapted result in the original body of data; simply all the documents and monuments are read out of the original body of data. From the finished output, a macro is then generated which replaces the record numbers in the raw adjacency list (‘raw-edge-list’) with the complete ‘Labelstring.’ The selection of the relevant entries then automatically results from the record numbers in the raw adjacency list.

In a further step, in the list enriched in this way, all the existing record numbers, that is ‘RecNoSelf,’ ‘RecNoParent,’ ‘RecNoMain’ and ‘RecNoEntity2’ are enriched again with the Labelstring using the same macro.

The final result is the raw form of the above described base list (FIG. 8).

5. Creation of the Matrix (step S3)

A good conventional table calculation can suitably serve as a matrix visualization tool. However, it is also possible to implement the described method in a genuine matrix application (in the absence thereof, see Daru, Myriam: Jacques Bertin and the graphic essence of data. Information Design Journal 10(1) 2001 pp. 20-25). The only real limitation on the table calculation relative to a desirable matrix tool is the existing limitation of the column count to 256. All other limitations primarily concern the comfort of the user interface and the calculation speed, which can certainly be increased significantly when the application is adapted to the desired purpose.

A scheme of the procedure in principle on production of a matrix from the base list is given in FIG. 10 (detail from FIG. 7):
First, for the multitudes of link starting nodes and link destination nodes, in each case, a Nodeset is extracted from the base list. Suitably, the classification criteria-Nodeset usually results in the columns of the matrix, whilst the object-Nodeset leads to the rows. Both Nodesets are made up from the information that is present in the respective sub-group of the base list. Primarily, only the record number (that is, the ID) of the respective nodes is required. All further information is used for later sorting of the matrix or for quick identification of the entries.

If globally or metalocally grouped Main and Entity2-Nodesets are extracted from the base list, then any redundancies present before insertion into the matrix are filtered out so that each classification criterion complex or object complex occurs only once in the relevant Nodeset. Following filtration and possible pre-sorting, the Nodesets are copied into an empty table (see FIG. 11).

In the case of metalocal Entity2 matrices and local self-matrices, the ‘Label’ of the nodes contained in the ‘Labelstring’ is possibly distributed among different cells—in the manner of “Book”|“Chapter”|“Figure” rather than “Book/Chapter/Figure,” to be able to perform sorting polyhierarchically.

In the case of matrix creation (in contrast to classical network visualization), the Edgeset does not generally have to be extracted from the base list. The relevant sub-group in the third column group (FIG. 8c) is sufficient despite the redundancy it includes.

Filling of the matrix takes place through simple checking whether the relevant record number combination of origin and destination nodes is present in the respective sub-group of edges in the base list. In every cell of the matrix table that is to be filled in, a command according to the following example serves this purpose (in the format of Excel 2002™):

=IF((COUNTIF(e;(CONCATENATE(x;“$”;y)))>0);(CONCATENATE(x;“$”;y));0).

e denotes the relevant edge column in the base list (e.g., ‘[Baselist.xls]edges’!$AP:$AP); x and y are variables which identify the respective origin and destination nodes. In the example shown, the link starting node record number is found in the cell x (e.g. $EU22), and the link target record number is in the cell y (e.g. ET$20).

Once the matrix has been calculated, in the table calculation, the dynamic values may possibly be converted into fixed values, zeros removed and a suitably conditional cell formatting applied (e.g., background black if the cell content is not equal to 0). A finished matrix 5 is illustrated by way of example in FIG. 11.

6. Generation of the Image Matrix (step S4)

### 6.1. Main Steps

Once the matrix 5 is complete, the generation of the image matrix 6 is divided technically into two sections.

Firstly, the ‘edge labels’ are created which comprise either the respective link starting nodes, that is, the document (portion), or if the ‘Edge-Occurrence’ has a higher value than one, a plurality thereof.

The second section after creation of the edge labels concerns the actual visualization of the image matrix. For this purpose, the matrix is firstly appropriately sorted, filtered and, if needed, transposed. Finally, in an automatic step, the actual image table is generated (FIG. 12).

FIG. 12 shows, by way of example, a section of the image matrix which, in practice, can be significantly larger and can include, for example, 200 columns and 2000 rows.

The complete general procedure follows the scheme shown in FIG. 7. Due to the complexity of the representation, it is important to note that all the deviations shown can be automated. For the user (e.g., researcher), this means that following suitable implementation of the method, he can create an image matrix from a matrix at the press of a button.

### 6.2. Generation of the ‘Edgelabels’

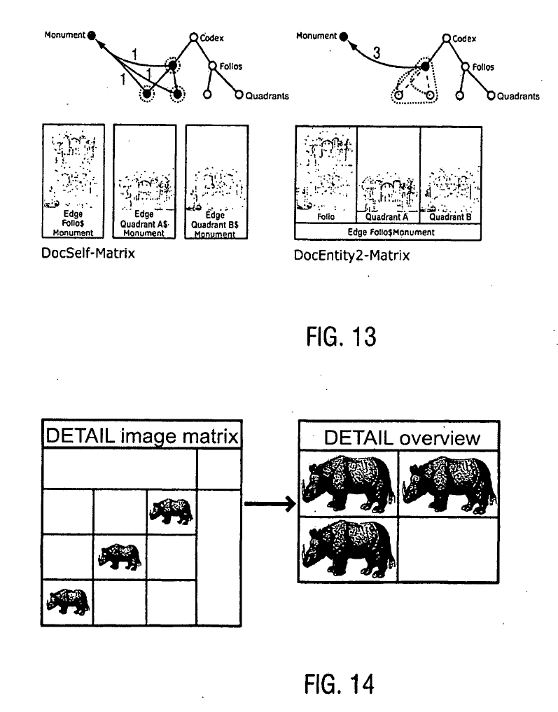

The generation of the ‘Edgelabels’ will now be described. As for the base list, they are created only once for all possible edges. Alternatively, it is also possible to create only the necessary ‘Edgelabels’ at the time point of the visualization ‘on the fly.’ The latter variant is advantageous for an implementation in a computer network, for example on the interne, to limit the data processing workload to the preparation of the actually required information. It should be noted, in general, that the ‘Edgelabels’ for all node groupings of global, metalocal and local type must be created separately. This is necessary since the ‘Edgeoccurence’ of similarly named edges in the different groupings can differ (see FIG. 13):
As stated above, the content of a cell, that is of an edge in the matrix does not necessarily correspond to the direct link relationship between the respectively grouped objects and classification criteria in the database. Rather, particularly in the case of globally or metalocally grouped matrix cells or matrix columns, a plurality of links can be grouped together in one edge.

The edge between the folio and the monument in FIG. 13, for example, represents in a locally grouped matrix (‘DocSelf-Matrix’), only the direct link (which also exists in the body of data) between the folio and the monument. In a metalocally grouped matrix (‘DocEntity2-Matrix’), the same edge between the folio and the monument represents a total of three links existing in the body of data: the link Folio-Monument and two further links between the quadrants and the monument parts.

From this it follows that the matrix, particularly in the grouped form, is an independent product the expressiveness of which can exceed the content of the body of data in its previous accessibility.

In the following, the image matrix will be encoded, by way of example, in HTML. The content of the ‘Edgelabels’ is therefore defined as an HTML table cell:

Content of the table cell (generally):

<a href=“Edgelink”>
<img src=“EdgeImage” border=“0” alt=“EdgeAltText”>
<br>EdgeLabel</a>

Content of the table cell for Occurrence = 1:

<a href=“.../Database?RecNo”>
<img src=“.../RecNoDocument.jpg or. .../RecnNoArchetyp.jpg”
border=“0” alt=“Labelstring of RecNoDocument and EdgeLabel”>
<br>node Recno</a>

Content of table cell for Occurrence > 1:

<a href=“DetailMatrix.htm or Detailoverview.htm”>
<img src=“Detailmatrix.jpg of Detailoverview.jpg” border=“0”
alt=“Labelstring of RecNo(Parent)Document and EdgeOccurrence”>
<br>Edge RecNoDocument$RecNoMonument</a>

The content of the table cell of each edge receives three components in the image matrix apart from the designation (EdgeName): a depiction (EdgeImage), an explanatory text (EdgeAltText), which may possibly appear in the online version when the mouse cursor moves over it, and a link (EdgeLink) which enables navigation back to the database.

If the ‘Edge-Occurrence’ equals 1, then filling in the relevant parts is very simple, since all information from the Nodeset or Edgeset can be taken from the base list:
The ‘EdgeLabel’ represents the label of the associated link starting node, that is, for example, the (partial) document.
The ‘EdgeImage’ represents the respective depiction or that of the reprographically copied original (possibly made known by a frame or the like).
The ‘EdgeAltText’ contains arbitrary information from the respective Labelstring and, for better control, the name of the edge (Recno$Recno).
The ‘EdgeLink’ opens the link starting node, that is, the (partial) document in the database.

If the ‘Edge-Occurrence’ exceeds the value 1, then ideally in the place of the individual link starting node in the table cell a detail matrix appears, which itself contains the relevant link starting nodes. Since, in general, the depictions rapidly tend to become too small, it is advisable to show an overview depiction at the site of the detail matrix, containing only the filled cells of the detail matrix (FIG. 14).

The overview depiction appears at the site of the individual depiction in the ‘Edgeimg’ of the table cell. It must be separately created for all edges with multiple Occurrence, for which purpose a concordance is created from the base list, in which concordance all the record numbers of the link starting nodes and their depiction reference for a multiply occurring edge are collected. For each edge, an HTML file is then generated from the concordance. The file contains the name of the edge and enables navigation from the individually included nodes back to the original body of data. The HTML version of the overview depiction is then converted into an image file with the aid of a special tool (e.g., Html2jpg™), to be able to include it in the HTML version of the image matrix.

The finished ‘Edgelabel’ for values greater than 1 contains as the designation the original name of the edge in the form ‘recno$recno,’ as ‘Edgeimg’ the overview depiction, and as ‘Edgealttext’ the value of the ‘Edge-Occurrence’ of the edge and the ‘Label’ of the higher-level document complex. The ‘Edgelink’ suitably does not refer directly to the original body of data, since the relevant edge does not always represent an actually existing relationship, but rather a grouping together of such relationships. The links therefore suitably opens the interactive HTML version of the overview depiction, from the individual quadrants of which it is possible to navigate into the original body of data.

### 6.3. Generation of the Image Matrix

Once the ‘Edgelabels’ have been created for edge values equal to or greater than one, the matrices are enriched with the ‘Edgelabels’ making use of a plurality of macros. The first two macros replace the name of the edge in the matrix cell with the HTML table cell. The third macro generates the HTML overview tables and the fourth generates the relevant image files.

The enriched matrix can consequently be imported from the table calculation with a good HTML editor (for example, Adobe Dreamweaver™) into an HTML file and displayed in the browser as an image matrix.

An advantage of the procedure described is that, following the enrichment, the matrix retains its original form, that is, each filled cell appears as a black box, even after enrichment with the ‘Edgelabel.’ This means that the matrix can also be easily processed in the enriched form and rapidly converted into an image matrix.

Alternatively to this relatively static encoding of the matrix in a table calculation and the image matrix in HTML, it is also possible to store the overview depictions or the relevant detail matrices of multiple edges within the (image) matrix in an interactive form. This would ensure not only more convenient processing of the body of data, such as the merging of double entries and the issuing of links between the individually displayed nodes by ‘drag and drop’ or ‘point and click.’

### 6.4. Zooming the Matrix (Scaling)

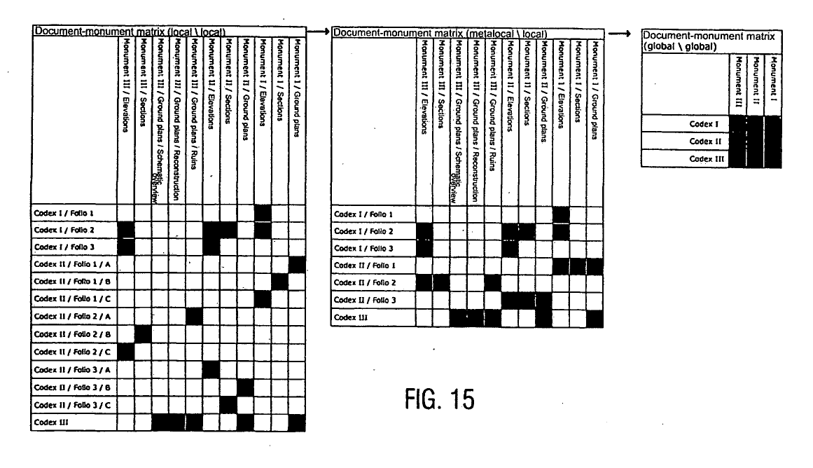

An important problem in the generation of suitable image matrices for the analysis of networks of classified image documents is the selection of useful groupings of the possibly hierarchical or grouped classifications and of the possibly suitably sub-divided image documents themselves. The selection of the respective grouping determines the possible size of the matrix (FIG. 15).

If, in a matrix,, all the directly linked nodes of the classification or of the documents stand alone (locally), then large complexes of nodes with numerous linked individual nodes may require several hundreds or even thousands of columns or rows. If, however, the classification criteria or document complexes are grouped together into the largest possible (global) unit, each complex occupies only one single row.

A matrix in which the documents are depicted exclusively locally, in the event of a body of data with 10,000 classification links would encompass up to 10,000 document rows and would therefore not be useful for direct human interaction. Furthermore, it would be impossible in such a matrix to create regions of useful density for an image matrix, since a large part of the lines would normally only contain very few filled cells. On the other hand, a matrix in which the documents are depicted purely globally prevents numerous detailed queries, since in many cells so many links are grouped together that a useful comparison would be prevented due to the excessive density.

Global grouping appears problematic, above all, in overview works such as exhibition catalogues or academic artistic corpus works in which, for example, not only one document (e.g., a city map) is included with various classifications (e.g., different representations of monuments), but several hundred thereof. In a relevant globally grouped row, hundreds of similarly classified representations (e.g., of a single monument) would be grouped together in a single matrix cell—and this appears to have as little usefulness for overview purposes as the spreading out to local nodes.

A possible solution to both problems lies, provided the documents and classifications are hierarchically sub-divided in multiple steps, in introducing metalocal units (i.e., for example, book/chapter/site rather than book/site). The metalocal unit and thus the multiple-stage hierarchical sub-division of documents into humanities databases as a whole finds its primary purpose here.

In the image matrix (as in every other display form of the data), the metalocal unit counters both excessive grouping together and excessive local fragmentation.

In the case of extensive catalogues or corpus works, for example, the individual catalogue entries can be grouped together within the publication. Consequently, detailed queries, such as regarding the classification of individual catalogue entries is possible with a direct visual comparison.

Used on a large scale, the introduction of relevant metalocal units into image matrices whose scope remains within a framework that is manageable for the human eye, but in which detail queries from the content of documents within the context of a further analysis are also possible. At the start of the analysis, it usually appears useful to compare the local depiction of the classification with a meaningful metalocal summary of the documents.

In principle, the rule of thumb applies that, in case of doubt, advance grouping into metalocal units should be dispensed with, since individual entries which belong together can also be grouped usefully in the matrix later. It is therefore sufficient to store only so many metalocal groupings such that a useful original size of matrix comes about. Further useful metalocal units are possibly recognized and stored later in the context of the analysis.

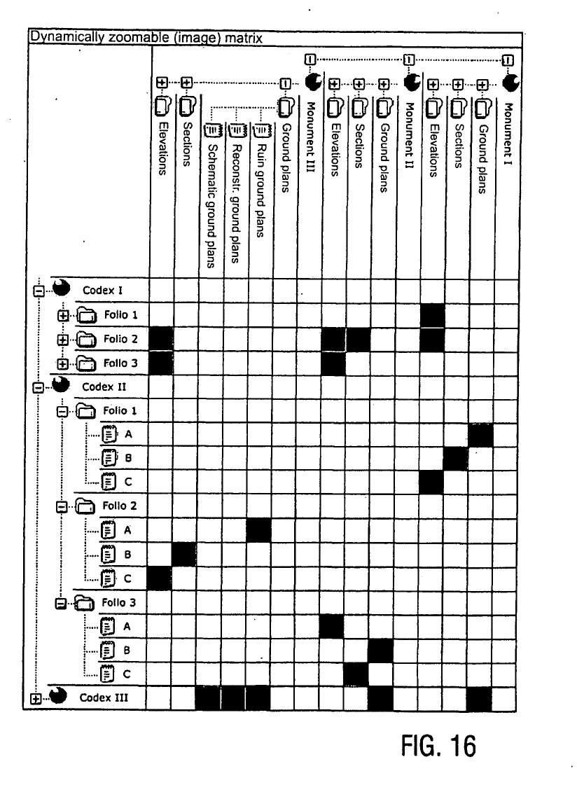

Zooming of the matrix takes place in discrete steps according to the following procedure:
Firstly useful groupings and fragmentations are stored in the context of the analysis in the original body of data. The new metalocal units become accessible in the following generation of matrices (refresh).
Alternatively, it is possible to make this discrete, step-wise sequence fluid, in that the tree structure of the classification and of the documents which may possibly be present at the edge of the matrix is made fully dynamically accessible, similarly to the index structure in the file explorer of an operating system (see FIG. 16; the image signs used in FIG. 16 can be the subject of registered marks). As in Windows Explorer™ or Mac Finder™, it is thus possible to zoom by unfolding and closing, even in selected regions of the matrix.

An implementation in this form is useful, above all, if both the classification criteria and the sub-division of the classified documents themselves correspond to the form of strict trees in the context of graph theory and these trees are not to be broken off by permutation of the parts (see Advantage 1).

### 7. Further Advantages of the Invention

### Advantage 1: Easier Handling of the Ambivalence of the Higher Unit.

Image information that is simultaneously visible in the image matrix enables the recognition and production of useful sortings or groupings (permutations) of a plurality of individual nodes and node complexes. It is also possible to play with the more or less developed subjectivity of the sub-division of the classification criteria or of the objects themselves. The roots of the possibly present strict node trees are virtually cut off for this purpose. As a consequence, information can be differently sorted and grouped together into alternative useful units. This produces new useful groupings of nodes which are not necessarily oriented to the usual physical division of the objects represented (e.g. drawings by one artist from different collections, a reconstruction project that is to be undertaken, or the like).

The groupings found are initially grouped together by permutation in the (image) matrix. The visual properties of the image matrix have a particularly advantageous effect in the context of this procedure, particularly with manual permutation, since the sorting criterion is always in view.

By means of border lines, the groupings formed are directly identified in the (image) matrix. Alternatively, however, they can also be firmly bound as ‘cognitive concepts’ (i.e., for example as virtual objects) into the original body of data. The ‘cognitive concepts’ are stored as a body of linked alias nodes and represent, in their further use as virtual (image) documents, the newly found groupings. They therefore offer an alternative to the existing physical order, but without destroying this order. Independent ‘cognitive concepts’ according to this definition can also serve to store the aforementioned montages in the original body of data.

### Advantage 2: Simpler Approach to the Establishment of the Correlation of (Image) Documents.

Possible reasons for the similarity of visual objects are a) direct dependency, b) indirect dependency, c) external reasons (for example, a prominent viewpoint in the case of compareable landscape pictures) or d) randomness.

The stronger the correlation between comparable visual objects, the more easily randomness can be excluded. All other causes are usually significantly harder to differentiate. The image matrix proves to be an extremely useful tool due to the image information contained therein, due to the two-dimensional matrix format and due, to its susceptibility to permutation.

Recognized direct dependencies (tradition-forming events) or other more precisely specifiable relation between two depictions can be stored in the image matrix, for example, by drawing in the link arrows (for example, by ‘drop and drag’ with the mouse). With suitable implementation, the image matrix can therefore serve as a convenient user interface for processing the original body of data.

Advantage 3: Extraction of Time-Bound Phenomena with Regard to the Objects and the Classification Criteria.

If the objects, as in the example above are, for example, medieval (image) documents, whilst the classification criteria are ancient monuments, then there is a uniform approach via art history and classical archaeology. Art history is dedicated to the time-bound phenomena of (image) documents based on classification criteria. Classical archaeology relates to the time-bound phenomena of classification criteria based on (image) documents.

In this context, the matrix serves two purposes:
a) Extraction of the history of the objects or the classification criteria (story-telling). Examples are the development of hand sketch books or the microhistory of a building detail.
b) Visual checking of whether selected classifications are actually relevant to the query on filtering the matrix (relevance checking).
c) In the case of the history of the classification criteria, the image matrix serves to exclude dependent representations, since only the respective first representation of a series of representations copied from one another is relevant. The exclusion criterion is direct dependencies which first come to light, inter alia, in the image matrix (see Advantage 4).
d) Improvement of the relative dating of imprecisely dated or undated objects. Vaguely dated nodes (for example, with the dating ‘17th century’ or with a before or after date) can be more precisely allocated based on the image information contained in the overview.

### Advantage 4: Easier Answering of Implicit Visual Detail Queries.

Since a plurality of objects classified according to the same criteria can be compared at a glance in the image matrix, it is also possible to investigate non-classified, that is, implicit details of the objects that are not verbally explicit in the classification.

In the case of historical (image) documents, which are classified according to the monument shown, it is possible, for example, to read the history of a particular window in a wall without the window explicitly being part of the classification criteria.

In general, visual detail queries in this form are useful if the higher-level classification criterion is also of a visual type.

### Advantage 5: Simplification of Data Analysis and Revision.

The image matrix facilitates data analysis and data revision since, for example, duplicated objects with different names and unidentified objects can be recognized by appearance and possibly merged or otherwise placed in relationship. If the classification criteria are of a visual type, suitable candidates automatically collect in the same matrix columns or rows.

### 8. Further Applications

Further applications that come into consideration are, for example:
a) Applications for the analysis of complex multitudes of data;
b) Maintenance and processing of (visual) quotation data (in this context, the method also facilitates bibliometric quality assurance);
c) Image science and art studies, particularly in the field of adoption, tradition-formation and mnemosyne. In addition, the method also proves to be very useful in the relative dating of imprecisely assigned objects (baroque painting, drawings, archaeology and the like);
d) Securing the copyright to images;
e) Data processing with imaging techniques in medicine (for example, for the simultaneous observation of the development of similar cancer metastases in several patients and/or organs), biology (research on the phylogeny of species and evolution in general), the study of art (discovering visual similarities in individual objects) or in other technical fields, for example, aerial reconnaissance (simultaneous representation of aerial image sequences from a plurality of locations); and
f) The administration of implicitly or explicitly classified bodies of image data (implicitly: image search engines; explicitly, for example, with tags and clusters).

The features disclosed in the above description, the drawings and the claims may be significant to the implementation in its different embodiments either individually or in combination.

1. A method for producing an image matrix comprising:
providing a network with a multitude of link starting nodes and a multitude of link destination nodes with links lying between them,
forming a matrix with rows and columns, wherein link starting nodes are assigned to the rows and link destination nodes are assigned to the columns or vice versa, and
placing visual representations of the link starting nodes or of the link destination nodes in place of the links in the matrix, resulting in the image matrix.

2. The method according to claim 1, wherein:
link starting nodes are classifiable objects and link destination nodes are classification criteria or vice versa.

3. The method according to claim 2, wherein:
at least one of the objects and classification criteria are objects from a body of persons, number of persons, locations, time periods, physical items, conceptual items, events and periods.

4. The method according to claim 2, wherein:
at least one of the objects and classification criteria are represented by individual nodes or groups of nodes.

5. The method according to claim 2, wherein:
in the case of a multi-valent link from or to a multi-part object or a multi-part classification criterion, a detail image matrix is placed.

6. The method according to claim 2, wherein:
in the case of a multi-valent link from or to a multi-part object or a multi-part classification criterion, a one-dimensional overview table is placed.

7. The method according to claim 2, wherein:
in the case of a multi-valent link from or to a multi-part object or a multi-part classification criterion, an image montage is placed.

8. The method according to claim 1, wherein:
multi-part, in particular hierarchically sub-divided, objects or classification criteria in the matrix are unfolded into a plurality of matrix rows or matrix columns.

9. The method according to claim 1, wherein:
multi-part, in particular hierarchically sub-divided, objects or classification criteria in the matrix are grouped together into one matrix row or matrix column.

10. The method according to claim 2, wherein:
at least one of the individual objects and classification criteria in the image matrix is bound based on precisely specifiable relationships.

11. The method according to claim 1, further comprising:
output of at least one part of the image matrix to an output device, in particular on a screen or a printer, or in a file.

12. The method according to claim 1, further comprising:
processing the data in the image matrix, and
at least one of a storage of the processed data and an output of a modified image matrix.

13. The method according to claim 12, wherein:
the data processing comprises at least one of the data input, image recognition, correlation and reordering of the data of the image matrix.

14. The method according to claim 13, wherein:
storage in a body of data is provided, from which preparation of the network takes place.

15. The method according to claim 1, wherein:
the method is carried out on an electronic data processing system.

16. The method according to claim, wherein:
additional information is placed at the matrix elements of the image matrix.

17. An electronic data processing system comprising a processor and a storage medium wherein the storage medium contains software which causes the processor to carry out the method according to claim 1.

18. A storage medium comprising software for an electronic data processing system with a processor wherein the software causes the processor to carry out the method according to claim 1.
